(19) United States
(12) Patent Application Publication
(10) Pub. No.: US 2025/0130308 A1
(43) Pub. Date: Apr. 24, 2025

(54) METHOD AND SYSTEM FOR DETERMINING THE LOCATION OF A SEISMIC EVENT

(71) Applicant: THE COMMONWEALTH OF AUSTRALIA, Edinburgh, South Australia (AU)

(72) Inventor: Daniel STEVENS, Edinburgh, South Australia (AU)

(21) Appl. No.: 18/686,781

(22) PCT Filed: Aug. 24, 2022
(86) PCT No.: PCT/AU2022/050977

§ 371 Date: Feb. 26, 2024

(30) Foreign Application Priority Data
Aug. 24, 2021 (AU) 2021902665

(51) Int. Cl. G01S 5/30

(52) U.S. Cl. CPC G01S 5/30

(57) ABSTRACT

A method and system for determining a location of a seismic event is described which comprises detecting three or more seismic signals in seismic activity associated with the seismic event that is monitored by three or more seismic signal detectors and for each of the detected signals detected by a respective signal detector then classifying, by the respective signal detector a corresponding detected signal with a respective frequency content classification based on determining whether a frequency content of the corresponding detected signal exceeds a frequency content threshold. The method and system further includes determining for each of the classified signals a respective seismic signal onset timing corresponding to an arrival time of the classified signal at the respective detector and determining the location of the seismic event based on the respective seismic signal onset timings and the respective frequency content classifications of each of the classified signals.

### PRIORITY DOCUMENTS

The present application claims priority from Australian Provisional Patent Application No. 2021902665 titled “METHOD AND SYSTEM FOR DETERMINING THE LOCATION OF A SEISMIC EVENT” and filed on 24 Aug. 2021, the content of which is hereby incorporated by reference in its entirety.

### TECHNICAL FIELD

The present disclosure relates to determining the location or origin of a seismic event. In a particular form, the present disclosure relates to determining the location of ordnance impacts.

### BACKGROUND

The task of determining the location of a seismic event may have many important applications not limited to the detection of earth tremors and the like. In one non-limiting application, the determination of the location of ordnance impact is an important task for the military either in the field or for training purposes. As an example, in the training of pilots undertaking bombing operations, determining where ordnance such as bombs and missiles has impacted the earth is important to assess the accuracy and reproducibility of deploying these types of munitions.

In one example approach for determining location of ordnance impacts, applicable for use on training ranges for air deployed weapons, cameras are used. Unfortunately, camera based systems are only able to observe what their field of view allows. Adverse weather conditions, low or transitionary light, high contrast objects, objects in the field of view and high bandwidth requirements all contribute to degradation of the capability of these types of systems. Furthermore, any camera's inherent field of view and depth of field characteristics will also limit the systems coverage area significantly unless multiple cameras are deployed which significantly increases the cost and complexity of the system. The use of unmanned aerial vehicles (UAVs) could possibly assist, but again these systems are also expensive and subject to robustness issues when deployed in the field.

Against this background, it would be desirable to provide a method and system that would determine the origin or location of low level seismic events, such as ordnance impacts, that could be deployed over large areas.

### SUMMARY

In a first aspect, the present disclosure provides method for determining a location of a seismic event comprising:
detecting three or more seismic signals in seismic activity associated with the seismic event that is monitored by three or more geographically spaced apart seismic signal detectors;
for each of the detected seismic signals detected by a respective seismic signal detector:
classifying, by the respective seismic signal detector a corresponding detected seismic signal with a respective frequency content classification based on determining whether a frequency content of the corresponding detected seismic signal exceeds a frequency content threshold;
determining for each of the classified seismic signals a respective seismic signal onset timing corresponding to an arrival time of the classified seismic signal at the respective seismic signal detector; and
determining the location of the seismic event based on the respective seismic signal onset timings and the respective frequency content classifications of each of the classified seismic signals.

In another form, the frequency content threshold varies in accordance with an ambient frequency content for the respective frequency content classification.

In another form, determining for each of the classified seismic signals the respective seismic signal onset timing comprises determining when the frequency content of classified seismic signal exceeded the frequency content threshold.

In another form, classifying by the respective seismic signal detector the corresponding detected seismic signal with the respective frequency content classification comprises:
deconstructing the corresponding detected seismic signal into a plurality of frequency bands; and
determining the respective frequency content classification by identifying in which frequency band or bands the seismic signal exceeds the frequency content threshold.

In another form, detecting three or more seismic signals in seismic activity monitored by three or more seismic detectors comprises determining for each of the seismic signals whether a power measure of the seismic signal exceeds a power measure threshold.

In another form, the power measure threshold varies in accordance with an ambient value of the power measure.

In another form, the power measure is a normalised harmonic power of the seismic signal and the power measure threshold is a harmonic power threshold.

In another form, a duration that the power measure of the seismic signal exceeds the power measure thresholds defines a time window for the seismic signal for classifying the seismic signal.

In another form, determining the location of the seismic event comprises:
determining an initial location estimate of the seismic event;
determining a time of flight for each detected seismic signal based on a distance between its respective seismic signal detector and the initial location estimate and a velocity estimate based on the respective frequency content classification of the corresponding detected seismic signal; and
varying the initial location estimate to minimise the difference between the determined time of flight and the measured onset timing for each detected seismic signal to determine the location of the seismic event.

In another form, determining the initial location estimate of the seismic event comprises determining an initial location area based on an order of arrival of the three or more seismic signals based on the respective seismic signal onset timings of the classified seismic signals.

In another form, the seismic event is an ordnance impact.

In another form, the method further comprises determining whether the ordnance impact corresponds to an exploded ordnance or an unexploded ordnance.

In another form, determining whether the ordnance impact corresponds to an exploded ordnance or an unexploded ordnance comprises determining whether the frequency content in an acoustic frequency band exceeds an acoustic frequency threshold.

In another form, determining the respective seismic signal onset timing is determined by the respective seismic signal detector.

In another form, the location of the seismic event is determined substantially in real time following detecting the three or more seismic signals.

In a second aspect, the present disclosure provides a location determining system for determining the location of a seismic event comprising:
three or more geographically spaced apart seismic signal detectors for monitoring seismic activity associated with the seismic event, each of the three or more seismic signal detectors comprising one or more data processors and configured for:
   detecting a seismic signal in seismic activity monitored by the seismic signal detector; and
   classifying a corresponding detected seismic signal with a respective frequency content classification based on determining whether a frequency content of the corresponding detected seismic signal exceeds a frequency content threshold;
a server module comprising one or more data processors and configured for:
   determining for each of the classified seismic signals a respective seismic signal onset timing corresponding to an arrival time of the classified seismic signal at a respective seismic signal detector of the three or more seismic signal detectors; and
   determining the location of the seismic event based on the respective seismic signal onset timings and the respective frequency content classifications of each of the classified seismic signals.

In another form, the frequency content threshold varies in accordance with an ambient frequency content for the respective frequency content classification.

In another form, determining for each of the classified seismic signals the respective seismic signal onset timing comprises determining when the frequency content of classified seismic signal exceeded the frequency content threshold.

In another form, classifying the corresponding detected seismic signal with the respective frequency content classification comprises:
deconstructing the corresponding detected seismic signal into a plurality of frequency bands; and
determining the respective frequency content classification by identifying in which frequency band or bands the deconstructed seismic signal exceeds the frequency content threshold.

In another form, detecting three or more seismic signals in seismic activity monitored by three or more seismic detectors comprises determining for each of the seismic signals whether a power measure of the seismic signal exceeds a power measure threshold.

In another form, the power measure threshold varies in accordance with an ambient value of the power measure.

In another form, the power measure is a normalised harmonic power of the seismic signal and the power measure threshold is a harmonic power threshold.

In another form, a duration that the power measure of the seismic signal exceeds the power measure thresholds defines a time window for the seismic signal for classifying the seismic signal.

In another form, determining the location of the seismic event comprises:
determining an initial location estimate of the seismic event;
determining a time of flight for each detected seismic signal based on a distance between its respective seismic signal detector and the initial location estimate and a velocity estimate based on the respective frequency content classification of the corresponding detected seismic signal; and
varying the initial location estimate to minimise the difference between the determined time of flight and the measured onset timing for each detected seismic signal to determine the location of the seismic event.

In another form, determining the initial location estimate of the seismic event comprises determining an initial location area based on an order of arrival of the three or more seismic signals based on the respective seismic signal onset timings of the classified seismic signals.

In another form, the seismic event is an ordnance impact.

In another form, the system further comprises determining whether the ordnance impact corresponds to an exploded ordnance or an unexploded ordnance.

In another form, determining whether the ordnance impact corresponds to an exploded ordnance or an unexploded ordnance comprises determining whether the frequency content in an acoustic frequency band exceeds an acoustic frequency threshold.

In another form, where instead of the server module, each of the three or more seismic signal detectors is configured for determining a respective seismic signal onset timing corresponding to an arrival time of the classified seismic signal at the respective seismic signal detector.

In another form, the location of the seismic event is determined substantially in real time following detection of three or more seismic signals

In a third aspect, the present disclosure provides a location determining system for determining the location of a seismic event comprising means to carry out the first aspect.

In a fourth aspect, the present disclosure provides a location determining system for determining the location of a seismic event comprising:
one or more processors; and
a memory for storing one or more programs, wherein
when the one or more programs are executed by the one or more processors, the one or more processors are configured to implement the method according to the first aspect.

In a fifth aspect, the present disclosure provides a non-transitory computer-readable medium for determining the location of a seismic event comprising instructions stored thereon, that when executed on a processor, perform the steps of the method according to the first aspect.

### BRIEF DESCRIPTION OF DRA WINGS

Embodiments of the present disclosure will be discussed with reference to the accompanying drawings wherein:

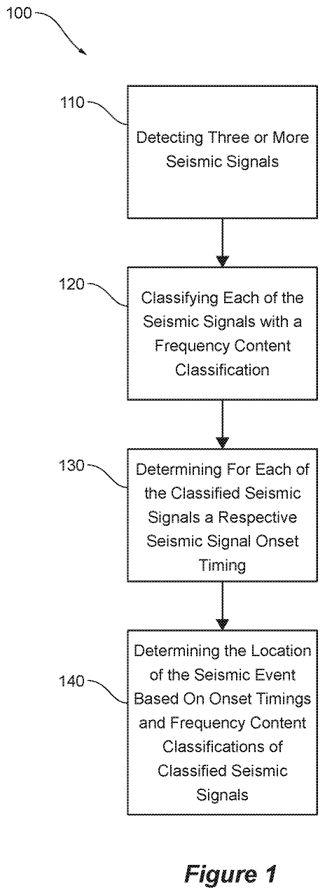

FIG. 1 is a flowchart of a method for determining the location of a seismic event in accordance with an illustrative embodiment;

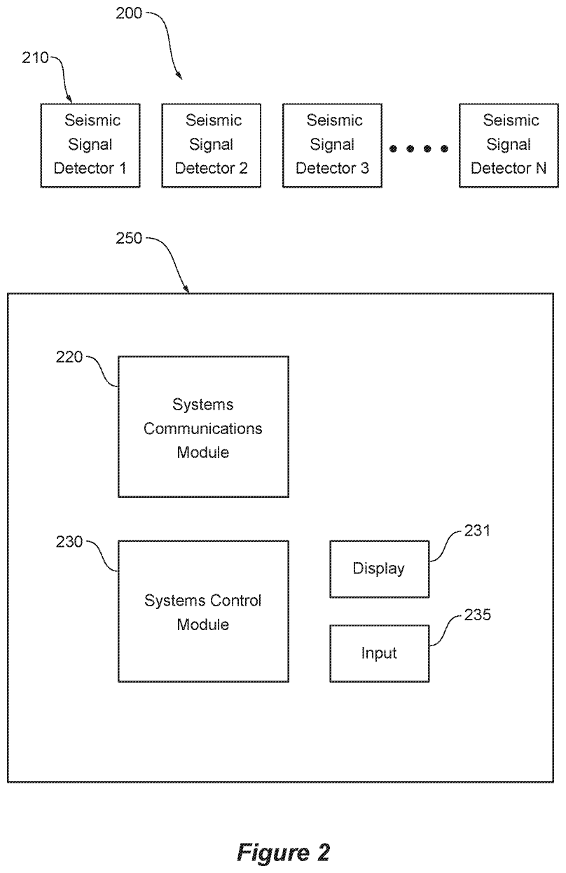

FIG. 2 is a system overview diagram of a location determining system for determining the location of a seismic event operable in one example embodiment to implement the seismic event detection method illustrated in FIG. 1;

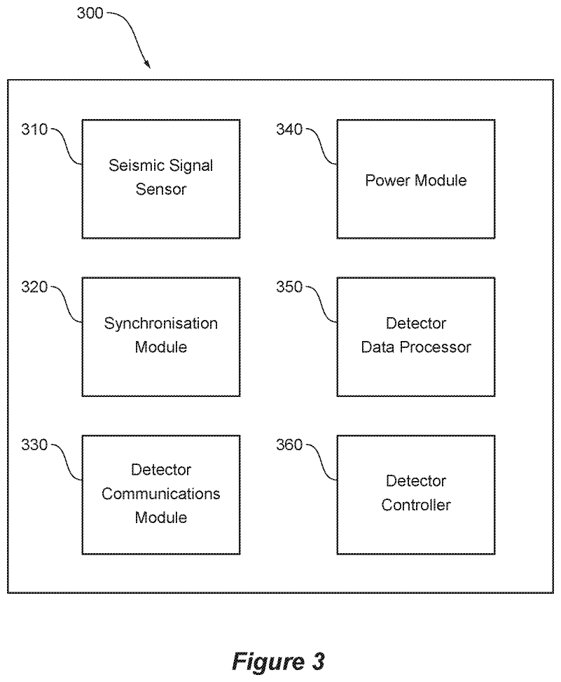

FIG. 3 is a system overview diagram of an individual seismic signal detector in accordance with an illustrative embodiment that may be implemented in the location determining system illustrated in FIG. 2;

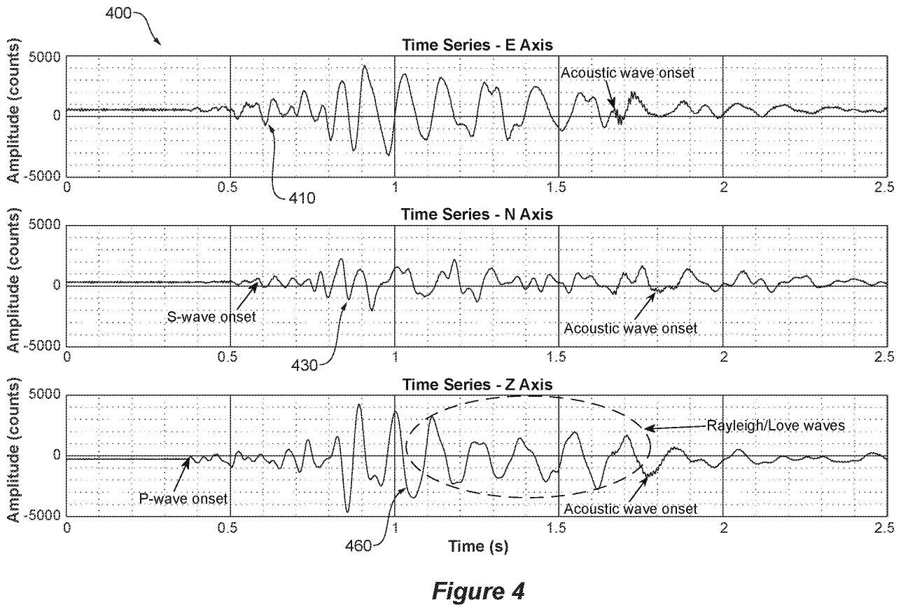

FIG. 4 is a plot of three seismic signal time series corresponding to the three axes of a seismometer showing the different seismic signal components in accordance with an illustrative embodiment;

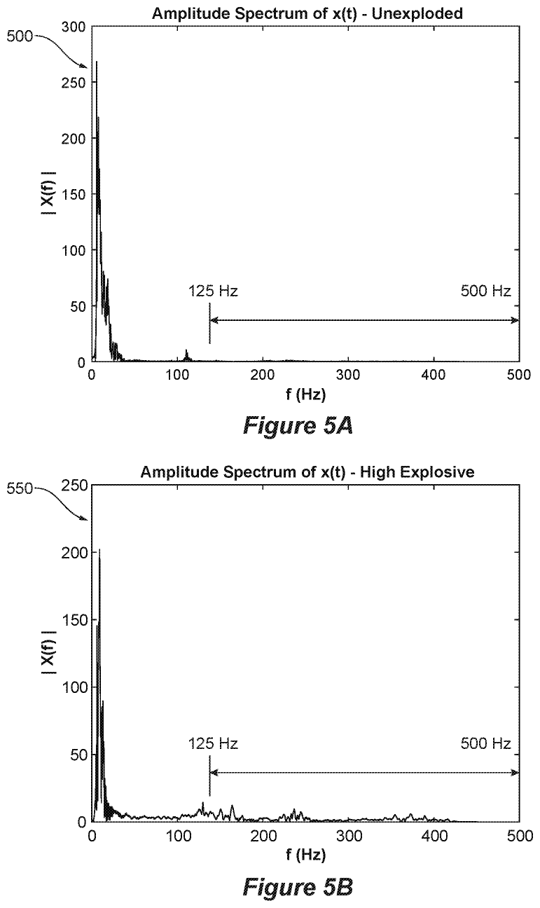

FIGS. 5A and 5B are frequency spectrum plots of the seismic signals corresponding to seismic events in the form of an ordnance impact and an ordnance impact followed by an explosion respectively in accordance with an illustrative embodiment;

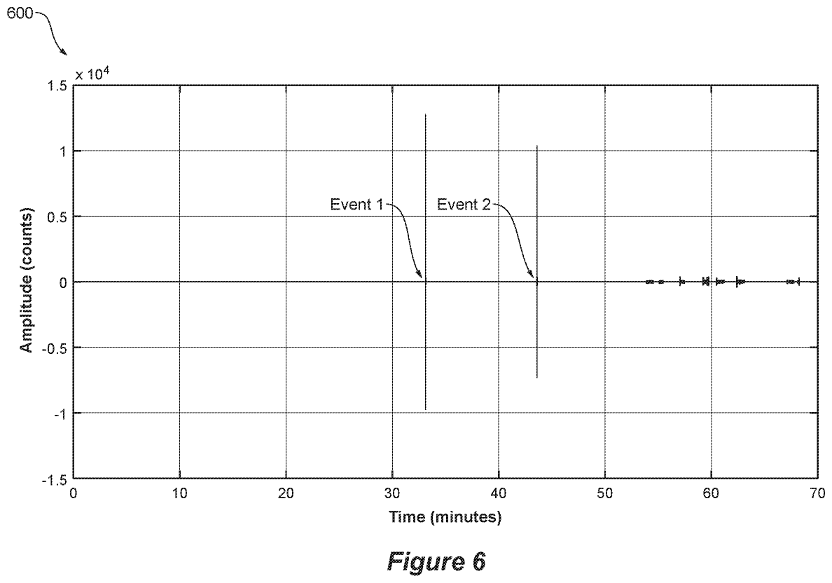

FIG. 6 is plot of seismic signal time series showing the presence of a number of seismic events in accordance with an illustrative embodiment;

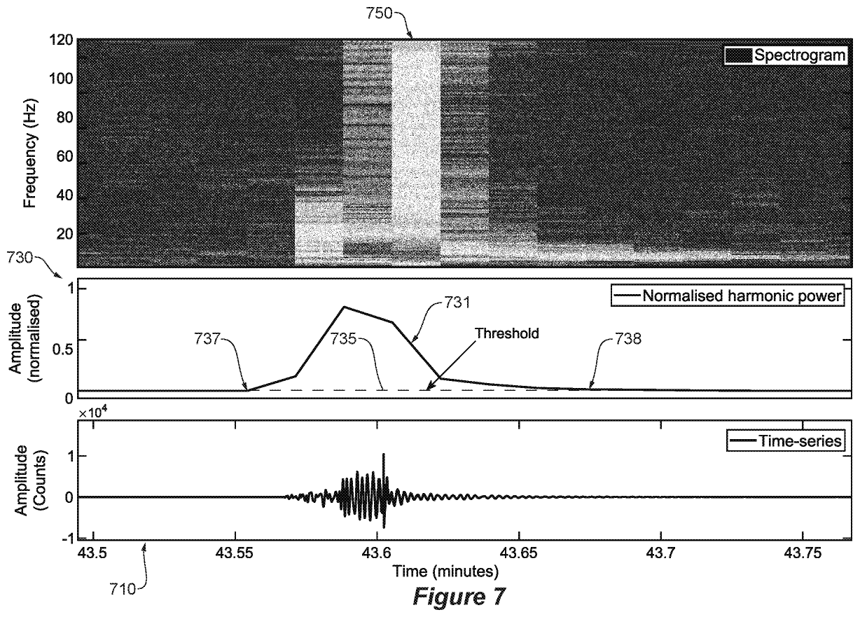

FIG. 7 is a series of plots corresponding to “Event 2” of FIG. 6 comprising the seismic signal, the associated normalised harmonic power and spectrogram in accordance with an illustrative embodiment;

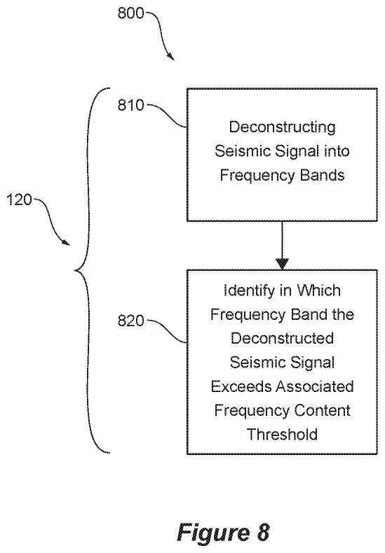

FIG. 8 is a flowchart of a method for classifying a seismic signal with a frequency content classification in accordance with an illustrative embodiment;

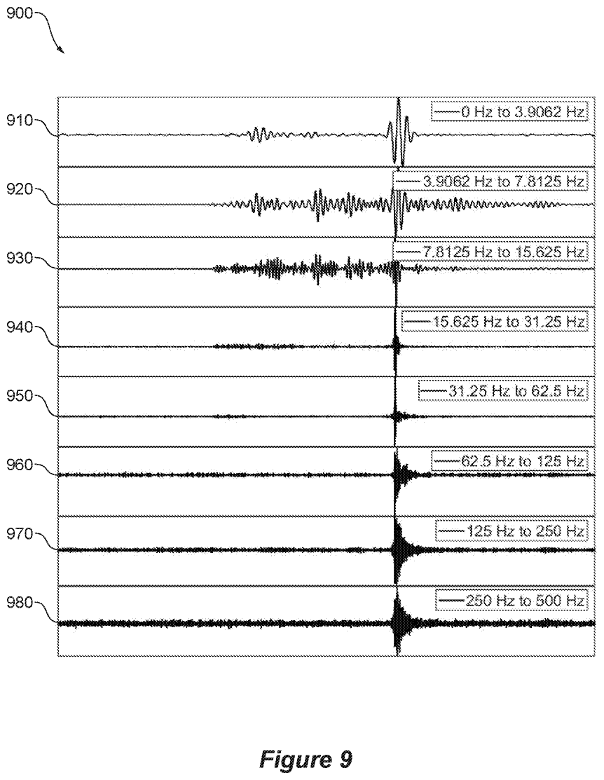

FIG. 9 is a plot of the reconstructed seismic signal portions in a number of frequency bands in accordance with an illustrative embodiment;

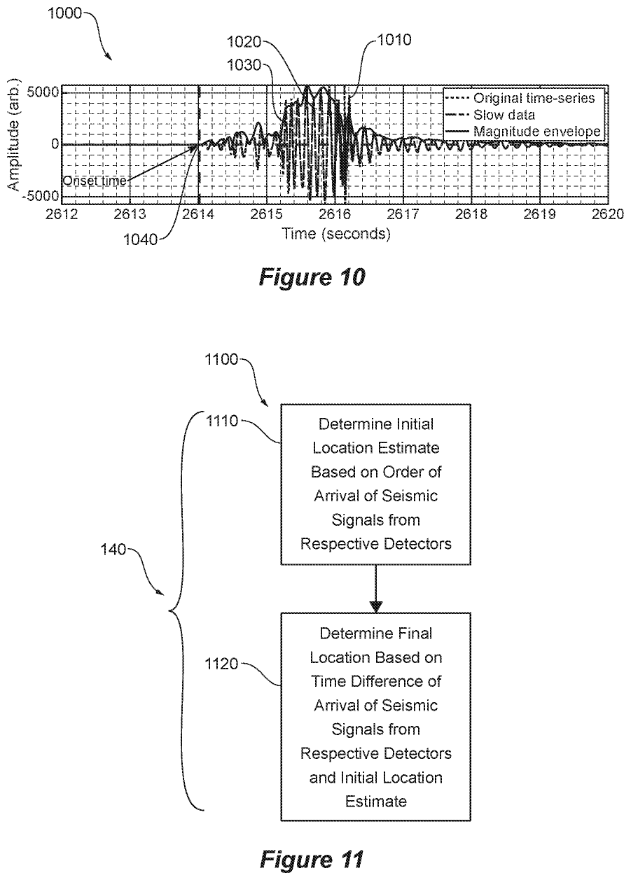

FIG. 10 is a plot of the reconstructed seismic signal portion in a selected frequency band (ie, “slow data” frequency content classification) in accordance with an illustrative embodiment;

FIG. 11 is a flowchart of a method for determining the location of a seismic event from seismic signal onset timings in accordance with an illustrative embodiment;

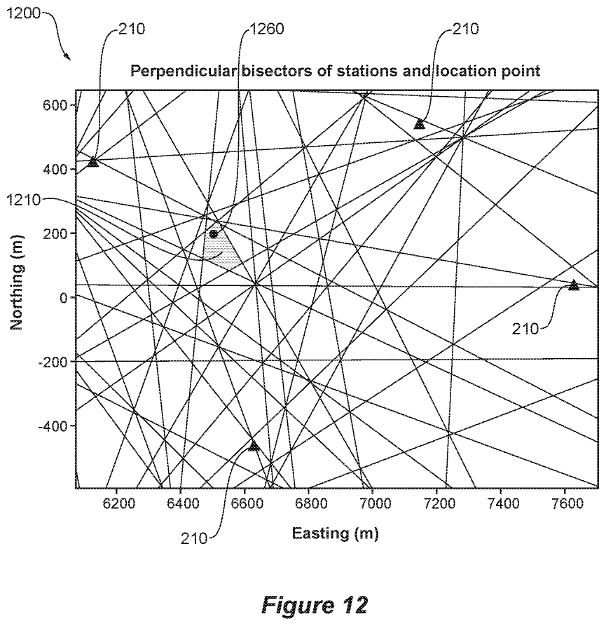

FIG. 12 is a plot of an initial area estimate for the location of a seismic event in accordance with an illustrative embodiment;

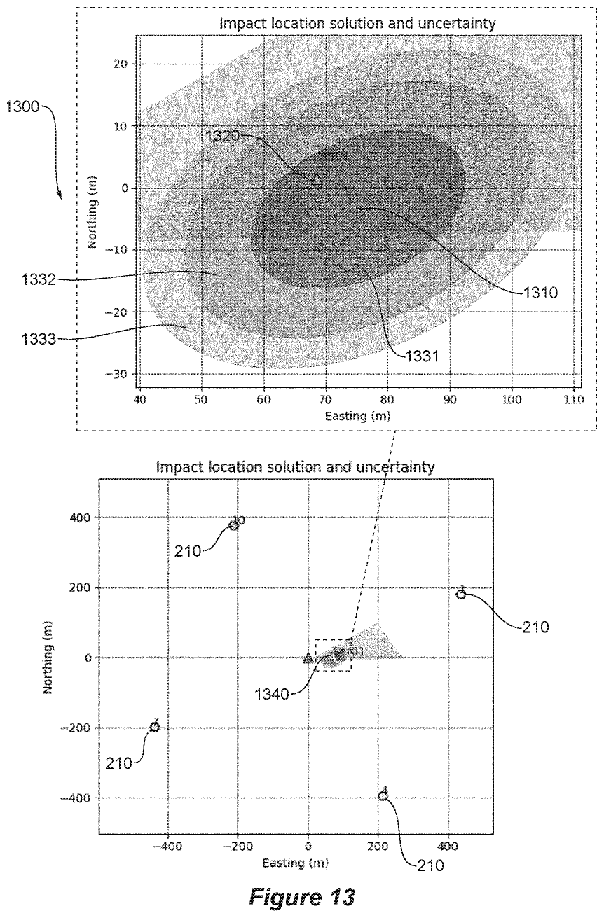

FIG. 13 is a plot of the location of a seismic event (shown in magnified region) as determined in accordance with an illustrative embodiment as compared to the actual location of the seismic event; and

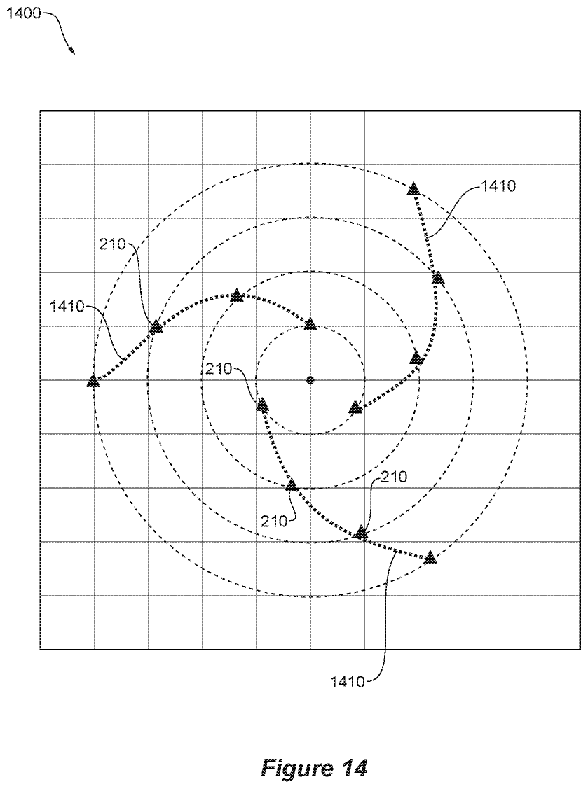

FIG. 14 is a plot of a spiral arm configuration for the placement of seismic signal detectors in accordance with an illustrative embodiment.

In the following description, like reference characters designate like or corresponding parts throughout the figures.

### DESCRIPTION OF EMBODIMENTS

Referring now to FIG. 1, there is shown a flowchart of a method 100 for determining a location of a seismic event according to an illustrative embodiment. In FIG. 2 there is shown a system overview diagram of a location determining system 200 for determining a location of a seismic event according to an illustrative embodiment operable in one example to implement method 100 as will be described below. In this example, location determining system 200 comprises three or more seismic signal detectors 210 that will be spaced over an extended region of interest encompassing or covering where the expected location of the seismic event may occur. Location determining system 200 further includes a server module 250 that communicates with the individual seismic signal detectors 210 as will be described below. In this illustrative embodiment, server module 250 comprises a systems communication module 220 and a system control module 230 which further comprises a display 231 and input means 235.

In one example implementation, location determining system 200 may also include one more optional relay modules (not shown) spaced over the region of interest to increase the communication range between seismic signal detectors 210 and the server module 250 by automatically listening and transmitting messages from the seismic signal detectors 210 to the server module 250 and vice-versa.

Throughout this specification the term “seismic event” is taken to mean an uncharacteristic ground motion at a location of interest that occurs over a defined time period causing a vibration in the form of a seismic signal to be transmitted through the earth and/or environment above the earth's surface. In some examples, the defined time period may be relatively short and effectively instantaneous. In other examples, the location may be at the ground surface or at a depth beneath the earth's surface. The generated vibration or seismic signal may extend over a frequency range commencing at approximately 5 Hz and extend to frequencies in the acoustic band, ie frequencies of up to approximately 500 Hz.

In one example embodiment, the seismic event occurs effectively at the ground surface and relates to ordnance impacts when the ordnance strikes the ground. In this example, the depth travelled into the ground surface by the ordnance impact is minute and negligible relative to the distance of seismic signal detectors from the location of the ordnance impact.

At step 110 of method 100, three or more seismic signals are detected by three or more seismic signal detectors 210 where the three or more detectors are each located at respective predetermined locations each forming a “node” of location determining system 200. In one example, at least four seismic signal detectors 210 are used. As would be appreciated, the number of seismic signal detectors 210 will depend on system requirements and it is not necessarily the case that an increasing number of detectors results in an increasingly accurate determination of the location of the seismic event.

Referring now to FIG. 3, there is shown a system overview diagram of a seismic signal detector 300 in accordance with an illustrative embodiment that may form part of the location determining system 200 (ie, corresponding to the example seismic signal detector 210 illustrated in FIG. 2).

In this example embodiment, seismic signal detector “node” 300 comprises the following components:
seismic signal sensor 310;
synchronisation module 320;
detector communications module 330;
power module 340;
detector data processor 350; and
detector controller 360.

Seismic signal sensor 310 is a device that is configured to respond to movement or motion of the ground at the location of sensor (ie, seismic activity) and then convert this measured movement to an electrical signal which may be monitored, stored and analysed.

In one example, seismic signal sensor 310 is a single channel device capable of measuring movement in one directional axis (eg, in the Z direction corresponding to vertical movement in the local up down direction). In another example, seismic signal sensor 310 is a three channel device capable of measuring movement in three perpendicular directional axes (eg, Z (vertical-down), X (transverse-north) and Y (radial-east)). The three axis device can provide enhanced detection for various seismic component signals resulting from the seismic event which would be expected to translate more energy though a particular directional axis.

In one embodiment, seismic signal sensor 310 is a three channel seismometer for measuring the velocity of ground motion and comprises a L28-3D geophone manufactured by Sercel™. This example seismometer has a natural frequency of 4.5 Hz, is critically damped and has a sensitivity of 30.4 Volts/meter/see and utilises a mass on a spring which moves and generates a corresponding voltage output. The instrument is passive requiring no power source and further incorporates an alignment arrangement comprising in this example of a levelling bubble and a “north” arrow to ensure correct directional alignment.

For the example application of determining the location of a seismic event corresponding to an ordnance impact with the ground surface, the L28 geophone was selected as its natural frequency (which typically indicates the bottom corner or cut-off frequency above which there is a flat response) is immediately below the expected seismic component signal that is expected to be measured (ie, a P-wave of approximately 6.5 Hz). For other applications, the natural frequency and associated response characteristics (eg, bandwidth, coil travel) of the seismometer may be chosen in accordance with the expected frequency range of the seismic component signal being measured that in turn corresponds to the seismic event.

In another example, the seismic signal sensor 310 may be a sensor for measuring the acceleration of a ground motion such as a Micro Electro Mechanical Sensor (MEMS), interferometer or other ground acceleration measuring device (in contrast to ground velocity) depending on the application. These sensors may be indicated where a higher bandwidth and robustness is indicated for the type of seismic event that is being detected.

While the above seismic signal sensors may have a range of bandwidths, these sensors will detect signals having frequencies of up to 500 Hz. As such, these sensors will also detect signals associated with the seismic event in the acoustic band where the seismic signal sensor is configured to sample the above ground environment. In other embodiments, the seismic signal sensor may comprise a separate sensor that is optimised to detect frequencies in the acoustic band of interest.

In one example, seismic signal sensor 310 is coupled to the ground surface. In one embodiment, this coupling is achieved by using a concrete or plaster of Paris footing for in this example the seismometer. In another example, more suited to temporary installations, coupling to the ground is achieved by the use of paving sand which has been wetted and allowed to set as a result providing satisfactory coupling to the ground but still allowing the seismic signal sensor 310 to be removed if required.

In other embodiments, seismic signal detector 300 may comprise additional sensors for sensing environmental conditions that may be of relevance. In one example, seismic signal detector 300 further includes temperature and relative humidity sensors to assist in the characterisation of acoustic band measurements that may be measured by seismic signal detector 300. In one example implementation, a Sensirion™ SHT20 12C temperature and humidity sensor is adopted which provides+3% relative humidity and +0.3 C temperature measurements.

Seismic signal detector 300 in this example further comprises a synchronisation module 320 to allow synchronisation of multiple detector nodes. In one example, a GPS module is adopted to provide this synchronisation functionality allowing each seismic signal detector 300 to be synchronised based on the received GPS signal.

For the application of determining the location of where ordnance has impacted the ground surface, the timing, as a recommended minimum, needs to have a precision of 100 μs on all seismic signal detectors 300 in the network with differences of no more than 500 μs range across all the detector nodes. This results in a minimum 1 ms timing precision on the seismic signal data time series that is to be measured by seismic signal sensor 310.

In one example, a U-blox™ NEO-6M GPS standalone GPS receiver may be adopted to provide a synchronisation signal for synchronisation module 320. This receiver provides a pulse-per-second (PPS) signal which can then be used to synchronise an internal clock component also forming part of seismic signal detector 300 and in which in this embodiment is a component of detector controller 360 as will be described below.

In another example, a SAM-M8Q GPS receiver may be adopted to provide a synchronisation signal for synchronisation module 320. In other examples, other receiver systems may be used that provide enhanced global navigational information such as those provided by the GLONASS or GALILEO global navigation systems. These may be adopted, where multi constellation connections are used, to provide increased synchronisation accuracy and reliability if required.

In other embodiments, synchronisation module 320 may be based on a time sharing protocol based on communications between the network of seismic signal detectors 300. In one example, the Network Time Protocol (NTP) may be implemented to synchronise the seismic detectors 300 such as in smaller installations, where the seismic signal detectors 300 may be connected by Ethernet cable and standard NTP processes may be used. Similarly, for seismic signal detectors 300 communicatively connected by standard Wi-Fi, again standard NTP processes may be used. In another example implementation, a given seismic signal detector 310 node may be designated as an NTP server and any form of wireless or radio communication protocol may be used to exchange NTP information and synchronise all of the seismic signal detectors 300 over the network.

In another example, where a cellular network is available, a seismic signal detector 300 acting as an NTP server may connect to the cellular network through a standard 3/4/5G modem. In another example, each of the seismic signal detectors 300 may incorporate a 3/4/5G modem to allow individual synchronisation to cellular network time where it is available.

Detector communications module 330 of seismic signal detector 300 functions to provide data connectivity between seismic signal detectors 300 and any additional components that are located remotely to the detector node such as server module 250 which incorporates its own systems communication module 220 and a system control module 230 as referred to earlier. As would be appreciated, the communication type and protocols utilised will be governed by the required data transfer rates and spacing of the seismic signal detectors 300. Communications may be either “wireless” and/or “wired” depending on the implementation.

In one example directed to the determining the location of ordnance impacts, communications module 330 is based on the LoRa spread spectrum modulation protocol operating over 915 MHz. This protocol provides relatively long range radio frequency (RF) transmission with low power consumption. In one embodiment communications module 350 comprises a Heltec Automation™ WiFi LoRa 32 V2 module and an associated external 915 MHz antenna to increase the range of communications. In one example, the external antenna is configured as a 5 dBi monopole whip antenna with a ground plane that is designed to be placed on the ground. In this example implementation, communications module 330 has a transmit power of 20 dBm and a receiver sensitivity of −129 dB.

This implementation provides a reliable range between seismic signal detectors 300 of approximately 10 km with a bandwidth of 125 kHz, data rate of 5470 bps and a maximum payload of 230b ensuring that a large scale area can be covered by location determining system 200.

In another example, communications module 330 may be based on satellite communications (SATCOM) implementation. In another example, Wi-Fi may be used with highly directional antennas. In another example, communications module 330 may be based on standard wireless cellular communication protocols. In another example, communications module 330 may be based on wired communications such as Ethernet or fibre cable.

Seismic signal detector 300 further comprises, in this example embodiment, a power module 340 configured to manage and provide power to the detector node. In operation, even when seismic signal detector 300 is in SLEEP mode, the detector communications module 330 will be powered by power module 340 so that it may receive a WAKE command, eg, from server module 250, in order to fully power up seismic signal detector 300.

In this embodiment, seismic signal detector 300 is configured to run as an independent node and is self-sufficient in terms of power requirements. In this example, power module 340 comprises a battery, solar panel and associated regulator. In one example, the battery is a lead acid 400 Wh battery operable at 12 V to satisfy the current draw requirements of 550 mA when seismic signal detector 300 is operating under normal operating load conditions. In this example, seismic signal detector 300 can operate independently for approximately 60 hours without requiring solar charging. Other example battery configurations that may be adopted include, but are not limited to, Li-ion and LiFPO. When seismic signal detector 300 is in SLEEP mode the current draw is approximately 50 mA.

As referred to above, in this example power module 340 comprises an optional solar panel and regulator that substantially increases operating time dependent on weather conditions. In this example, a 160 W, 18 V foldable solar panel is employed.

Seismic signal detector further includes a detector data processor 350 which may be implemented using any data processing arrangement capable of receiving seismometer data in the form of a time varying analogue signal and converting this to digital seismic information in the form of time series data. In one example, detector data processor 350 may be configured as an analogue to digital converter (ADC) module whose configuration will depend on the seismic signal sensor 310 and the number of output channels as well as operating parameters such as gain, bandwidth, total harmonic distortion (THD) and the input noise and the format of the output digital information that is required.

As would be appreciated, the selection of an appropriate ADC relies on balancing performance, cost, flexibility and controllability. Regarding ADC performance, the considerations may include frequency response (transfer function), bit depth, total harmonic distortion (THD), dynamic range, sampling rates, input referred noise and signal-to-noise ratio (SNR). Regarding flexibility, the considerations may include number of channels, range of stable gain settings, input voltage range and power supply requirements. Regarding controllability, the considerations may include available communications protocols (I²C, I²S, time division multiplexing (TDM), SPI, UART etc.) and range of software programmable settings.

In one example directed to the determination of the location of seismic events corresponding to ordnance impacts, the ADC module is based around a Texas Instruments™ Quad-channel 768-kHz Burr-Brown™ audio analog-to-digital converter (ADC) with 122-dB signal to noise ratio (SNR) (Model No. TLV320ADC6140).

The TLV320ADC is a four channel, sigma-delta fully programmable low noise ADC that provides up to 768 kHz sampling rates, Inter-IC Sound (i2S), time division multiplexing (TDM) stream output, and left justified data outputs. This particular ADC device also has i2C serial communication protocol to allow for control signals. In this example, each of the seismic information channels from seismic signal sensor 310 is independently connected to channels 2-4 of the ADC module via a precision instrument amplifier that is configured to provide a voltage gain of 32 dB at a noise level of 7.5 nV/VHz. This translates to 237 μV of noise at 1 kHz. Full scale 1V RMS single ended inputs at the TLV320ADC, corresponding to the analogue data, are converted to a digital signal and output to the microcontroller via SPI interface. The TLV320ADC also incorporates a microphone bias which allows the inclusion of back electret microphones to improve systems high frequency response and also includes additional functions such as dynamic range enhancement, high resolution gain and phase calibration, on board filtering and an automatic gain controller.

Finally, seismic signal detector 300 in this illustrative embodiment comprises a detector controller 360 to coordinate and control the various modules and components of the node and any interaction with external components such as server module 250. In this example, the functionality of detector controller 360 includes, but is not limited to:
overall seismic detector system control including powering up of components via power module 340, conducting diagnostic testing and system status monitoring;
synchronising an internal clock for the seismic signal detector 300 with a synchronisation signal from synchronisation module 320;
initialising, controlling, sending and receiving data from detector communications module 330
initialising controlling, receiving, storing and processing digital signal information data from detector data processor 350;
carrying out the digital signal processing (see below) to automatically detect signals of interest;
appending time stamp information to each incoming sample from the ADC; and
constructing messages for the detector communications module 330 containing identification, timestamp, classification, quality of signal etc for transmission to system communication module 220.

In one example, detector controller 360 will start up seismic signal detector 300 from SLEEP mode where only detector communications module 330 is powered following receiving a start-up command from the systems communications module 220. Seismic signal detector 300 will awake and command the components to conduct self-diagnostics and log any potential anomalies or errors. As an example, the synchronisation module 320 will be activated and detector controller 360 will await the synchronisation signal which upon receiving will synchronise the internal clock of seismic signal detector 300 to the synchronisation signal.

Assuming successful start-up, the detector controller 360 commands seismic signal detector 300 to enter a monitoring mode where the seismometer 310 will commence monitoring seismic activity and generating analogue data which the detector data processor 350 will then process to digital data. In this example, detector controller 360 will apply a time stamp to the received time series data in accordance with the synchronised clock. Where there are additional sensors, such as temperature and humidity data, their corresponding time series data will be similarly time stamped and stored.

In one example, detector controller 360 is implemented utilising a Raspberry Pi™ 3B+ microprocessor in combination with a data storage device in the form of a solid state disk (SSD) having in one embodiment a capacity of 500 Gb. In this example, the Raspberry Pi microprocessor is capable of executing code written in Python and C/C++. As would be appreciated, other embedded microprocessor implementations may be adopted including, but not limited to systems based Linux, Real Time Linux, RTOS (Real Time Operating Systems), QNX and FPGA's (Field Programmable Gate Arrays).

It is instructive at this point to provide some background in relation to the components of a seismic signal. When there is ground movement, a seismic signal is produced comprising different wave or seismic signal components. These include P (primary) waves, S (secondary) waves, Love waves and Rayleigh waves. The first two waves, ie the P and S waves, are termed body waves and have the highest velocity. The P wave is a compression wave which is the fastest and has a typical velocity of 4500 m/s. This velocity is dependent on the medium type and may increase toward 8000 m/s as density increases.

The S wave is a transverse wave and moves considerably slower than the P wave at approximately 2400-2700 m/s, however, the magnitude of the S wave is generally significantly larger than the P wave. The S wave is also typically more frequency dispersive than the P wave, as a consequence also typically covering the frequency range of the P wave. Similar to the P wave, the velocity of the S wave is dependent on the density of the medium.

The Love wave and Rayleigh wave are slower again and are considered surface waves where medium density is lowest. The Love wave is a horizontal transverse wave with components both in the direction of travel and perpendicular (horizontal) to the direction of travel. The Rayleigh wave rolls through the earth surface in an elliptical fashion with components in both the z plane and the plane parallel to the direction of travel. These waves are typically highly dispersive leading to complex wave forms.

A further seismic signal component are acoustic waves generated by the seismic event which typically occur in the frequency band of 125 Hz to 500 Hz and which are further delayed behind the previously mentioned P, S, Love and Rayleigh waves.

Referring now to FIG. 4, there is shown a plot 400 of three individual seismic directional signals 410, 430, 460 corresponding to the same seismic event caused by the kinetic impact of an inert or unexploded bomb but in this case each seismic signal is from a respective directional axis of a three-axis seismometer (ie, E-axis, N-axis and Z-axis respectively) showing the different seismic signal components in each of the time series data from each of the directional channels.

As can be seen by inspection of seismic signal 460 corresponding to measuring ground motion in the Z-axis, the P wave onset timing can be seen at a time of approximately 0.4 seconds while for the seismic signal 430 corresponding to measuring ground motion along the N axis (in this example) the S wave onset timing may be seen arriving at a later time of approximately 0.6 seconds. Similarly, in the z-axis seismic signal 460 the Rayleigh/Love waves can be seen at an onset timing of approximately 1 second. Finally, the arrival of the acoustic wave can be seen in each of the seismic signals 410, 430, 460 as higher frequency oscillations in the seismic signals occurring at an onset timing of approximately 1.75 seconds. Due to the nature of the unexploded ordnance, the acoustic wave is present albeit, of very low magnitude. It is also not as distinguishable on all axes (eg, the N and Z-axes).

Following from above, a seismic signal detector 300 will initially experience seismic activity in the form of a P wave originating from the seismic event. As can be seen from FIG. 4, it has been found that a seismometer either configured to, or having a channel configured to, measure ground movement along the Z-axis (ie, seismic signal 460 of FIG. 4) will be particularly sensitive to the P wave seismic signal component including those generated by ordnance impacts.

Referring now to FIGS. 5A and 5B, there are shown frequency plots 500, 550 of the seismic signals corresponding to seismic events in the form of an ordnance impact and an ordnance impact followed by an explosion respectively in accordance with an illustrative embodiment.

The Applicant has found surprisingly that the seismic signal of such an ordnance impact has a consistent and specific seismic signature comprising a P wave seismic signal component at 6.5 Hz followed by a combined 6.5 Hz and 12 Hz S wave seismic signal component. Furthermore, and even more unexpectedly, it has been found that the seismic signature is substantially independent of the mass of the ordnance (eg, 500 lb-2000 lb) or whether the ordnance had exploded. Importantly, this seismic signature may be distinguished from background earth tremors which are typically found in the frequency range of 1 Hertz or less and other natural and artificial phenomena that create signatures at much higher frequencies. The Applicant has also found that the seismic signal also includes a seismic signal component corresponding to an acoustic wave (ie, an A wave in the approximate frequency range of 125 Hz-500 Hz) which as expected is present for exploded ordnance (eg, see plot 550) but is also present for unexploded ordnance (eg, see plot 500) and which may be advantageously employed to assist in determination of the location of the seismic event.

As referenced above, at step 110 of method 100 as shown in FIG. 1, three or more seismic signals are detected by three or more seismic signal detectors 210 where the three or more detectors are each located at respective predetermined locations each forming a “node” of location determining system 200.

In one example, determining whether there is a detection of a seismic signal comprises determining whether a power measure of the seismic signal exceeds a power measure threshold. In one example, the power measure is a normalised harmonic power of the seismic signal and the power measure threshold is a harmonic power threshold.

In one example, a potential seismic signal may be defined as x(t), where x(t) is the time series data determined by seismic signal detector 300. A Short Time Fourier Transform (STFT) is then carried out to generate a spectrogram corresponding to the seismic signal based on window function w, where the STFT is defined by:

$$X ( τ , ω ) = {\int }_{- ∞}^{∞} x ( t ) w ( t - τ ) {e}^{- i ω t} \qquad Equation 1$$

In this example, window function w is a Blackman window but in other embodiments the window function could be any suitable window function such as a Hamming or Kaiser window function. The spectrogram is then defined as the power spectral density or magnitude squared of the STFT:

$${\vert X ( τ , ω ) \vert}^{2} \qquad Equation 2$$

The normalised harmonic power, P_{TH}, may then be calculated over a defined time period from time t to t+n as follows:

$${P}_{TH} = {\sum }_{τ = t}^{t + n} {\vert X ( τ , ω ) \vert}^{2} \qquad Equation 3$$

If P_{TH} exceeds a harmonic power detection threshold, D_{P}_{_{TH}}, then a seismic signal is detected and a detection time envelope is defined commencing at the time P_{TH} exceeds D_{P}_{_{TH}} and terminating when a falling edge is detected where P_{TH} drops below the threshold D_{P}_{_{TH}}.

In one example, the harmonic power detection threshold varies in accordance with an ambient harmonic power. In one example, the total harmonic power P_{TH} is determined continuously for incoming signal time series data x(t) allowing a running mean μ_{P}_{_{TH}}(t) and a running standard variation σ_{P}_{_{TH}} (t) to be determined which characterises the ambient total harmonic power at a given time t.

In one example, D_{P}_{_{TH}} will vary as a function of time in accordance with an ambient harmonic power by determining a time varying harmonic power threshold as follows:

$${D}_{{P}_{TH}} ( t ) = {μ}_{{P}_{TH}} ( t ) = C {σ}_{{P}_{TH}} ( t ) \qquad Equation 4$$

where C is a constant and determines the sensitivity of the seismic signal detection.

Referring now to FIG. 6, there is shown a plot 600 of a time series of seismic data depicting two seismic signals corresponding to two separate seismic events as measured by seismic signal sensor 310 in respective seismic signal detector 300. As can be seen from plot 600, in this example, the two seismic signals corresponding to “Event 1” and “Event 2” are separated by approximately 10 minutes

Referring now to FIG. 7, there is shown a series of plots corresponding to “Event 2” of FIG. 6 comprising the time series data corresponding to the seismic signal 710, the associated normalised harmonic power 730 and spectrogram plot 750 according to an illustrative embodiment. As can be seen in harmonic power plot 730, where the normalised harmonic power 731 exceeds the harmonic power detection threshold 735 this then defines a detection envelope or time window beginning at commencement time 737 and ending at termination time 738.

In another embodiment, a continuous wavelet transform (CWT) may be adopted to determine the spectral characteristics of the seismic signal and determine whether the power of the seismic signal is above an initial threshold. While the CWT can provide better time-frequency resolution than a STFT, this approach can be more computationally intensive and this may be a consideration in any implementation.

Referring back to FIG. 1, at step 120 each of the detected seismic signals are classified with a frequency content classification based on determining whether the frequency content of a given detected seismic signal exceeds an associated frequency content threshold for that particular classification. In one example, the respective seismic signal detector that detects the corresponding detected seismic signal is operable to carry out this classification (eg, see seismic signal detector 300 in FIG. 3)

Referring now to FIG. 8, there is shown a flowchart of a method 800 for classifying a seismic signal with a frequency content classification which in one illustrative embodiment corresponds to step 120 of the method 100 for determining a location of a seismic event illustrated in FIG. 1.

At step 810, a seismic signal is deconstructed or decomposed into a plurality of frequency bands.

As would be appreciated the number and endpoint of the frequency bands may be varied depending on the seismic event whose location is being determined. In this example, a discrete wavelet transform (DWT) approach is adopted to reconstruct or generate the time series of the seismic signal portion that corresponds to the variation in the seismic signal for that particular frequency band.

To carry out the DWT, the detected seismic signal x(t) in the time window that exceeds threshold is first transformed into the frequency domain x[k] using a wavelet basis function and passed through a selection of related low pass filters (LPF) and high pass filters (HPF) known as quadrature mirror filters. Let l be the impulse response of a low pass filter, then:

$$y [ n ] = ( x * l ) [ n ] = {\sum }_{k = - ∞}^{∞} x [ k ] l [ n - k ] \qquad Equation 5$$

However, the signal is decomposed using both a LPF and HPF and as such, the LPF impulse response is denoted as l and the HPF impulse response is h. This leads to half of the frequencies existing in each respective filtered signal leading to:

$${y}_{l} [ n ] = {\sum }_{k = - ∞}^{∞} x [ k ] l [ 2 n - k ] \qquad Equation 6$$

$${y}_{h} [ n ] = {\sum }_{k = - ∞}^{∞} x [ k ] h [ 2 n - k ] \qquad Equation 7$$

In this example, at each level of decomposition, the time precision reduces by a factor of 2 and the frequency resolution increases by a factor of 2.

In this example, the deconstructed seismic signal portion time series corresponding to a given frequency band is generated having a timing resolution of 1 ms based on a sampling frequency of 1000 Hz. In this manner, each of the seismic signal portions will characterise the behaviour of the original seismic signal in each of the respective frequency bands in the time domain.

Referring now to FIG. 9, there is shown a plot 900 of the eight generated seismic signal portions in the corresponding eight frequency bands following deconstruction of the original detected seismic signal then generation of the relevant seismic signal portion for the given frequency band. As depicted in FIG. 9, the frequency bands adopted in this example comprise 0-3.90 Hz, 3.90-7.81 Hz, 7.81-15.62 Hz, 15.62-32.25 Hz, 31.25-62.5 Hz, 62.5-125 Hz, 125-250 Hz and 250-500 Hz (ie, bands 910-980). These frequency bands follow the standard form of a DWT decomposition where each band is formed by halving the previous band starting at the bandwidth of the original seismic signal (ie, 500 Hz). In this example, eight levels of decomposition have been carried out.

At step 820, the frequency content classification is determined by identifying in which frequency band the deconstructed seismic signal exceeds an associated frequency content threshold.

In one example, a Hilbert transform is applied to the seismic signal portion time series in the selected frequency band to determine the frequency content in the frequency band. In this example, the Hilbert transform generates a real-valued envelope of the input seismic signal and this envelope is derived from both instantaneous frequency a(t) and instantaneous phase θ(t) as follows:

$$\hat{x} ( t ) = H [ x ( t ) ] = \frac{1}{π} {\int }_{- ∞}^{∞} \frac{x ( τ )}{t - τ} d τ \qquad Equation 8$$

$$a ( t ) = \sqrt{{x}^{2} + {\hat{x}}^{2}} and θ ( t ) = arc tan ( \frac{\hat{x}}{x} ) \qquad Equation 9$$

$$h ( f ) = {\int }_{- ∞}^{∞} \sqrt{{x}^{2} + {\hat{x}}^{2}} {e}^{- j 2 π f t} dt \qquad Equation 10$$

In terms of implementation, the Hilbert transform may be determined by first taking the FFT of the deconstructed seismic signal time series and then generating the complex part using the Fourier coefficients. A phase offset is then applied to both the negative and positive frequencies and the inverse FFT may then be calculated.

In a similar approach to that applied to seismic signal detection, for each of the frequency bands there is then set a threshold D_{B}. In this case, the threshold is based on the associated frequency content in the frequency band as opposed to the total harmonic power. Where the deconstructed seismic signal exceeds the associated frequency content threshold for the particular frequency band then the originally detected seismic signal is classified with that frequency content classification.

In one example, the frequency content threshold for a particular frequency band corresponding to a frequency content classification varies in accordance with an ambient frequency content by taking the mean and standard deviation of a “quiet” period in order to characterise the local noise in the particular frequency band. As an example the detection threshold for a given band, D_{B} may be defined to be the mean signal determined in that band, ie μ_{B} plus come constant C times the standard deviation σ_{B} as follows:

$${D}_{B} = {μ}_{B} + {C}_{B} {σ}_{B} \qquad Equation 11$$

where C_{B} may depend on the particular frequency band, eg, the value for C_{B} differs between a frequency band corresponding to P wave detection, as an example, and a frequency band corresponding to an A wave detection.

In another embodiment, a matched filtering process may be adopted to classify a seismic signal with a frequency content classification based on whether a frequency content of the seismic signal exceeds an associated frequency content threshold. In this example, a template seismic signal representative of the target seismic signal having the desired frequency content is cross correlated with the input seismic signal. As an example, the template seismic signal may be a time domain representation of a P-wave as captured in seismic data during tests. Where the correlation between the matched filter template seismic signal and the input seismic signal is greater than an associated frequency content threshold, there is a likelihood that the signal of interest is present in the input seismic signal and the seismic signal may be classified accordingly. In one example, the associated frequency content threshold may vary in accordance with an ambient frequency content for the respective frequency content classification.

In a further embodiment, a short term average (STA) over long term average (LTA) approach (STA/LTA) may be adopted to classify a seismic signal with a frequency content classification based on whether a frequency content of the seismic signal exceeds an associated frequency content threshold. In this example, the ratio between short term amplitudes and long term trends is measured. This involves taking the short term average of n samples and dividing it by the long term average k. As the STA increases, the ratio increases and once an associated frequency content threshold is breached then the seismic signal is classified accordingly. In one example, the seismic signal is initially filtered by an LPF to reduce spurious detections. This method is known, however, to suffer from a high number of false positives and generally requires a human in the loop to analyse the results. Again, in one example the associated frequency content threshold may vary in accordance with an ambient frequency content for the respective frequency content classification.

Referring back to FIG. 1, at step 130 for each of the classified seismic signals a respective seismic signal onset timing is determined that corresponds to the arrival time of the classified seismic signal at a respective detector. In one example, the respective seismic signal detector that detects the corresponding classified seismic signal is operable to carry out this determination of the respective seismic signal onset timing (eg, see seismic signal detector 300 in FIG. 3).

In one example, determining the respective seismic signal onset timing comprises determining when the frequency content of classified seismic signal exceeded the associated frequency content threshold as this will be an indicator of the arrival time of the classified seismic signal at a respective detector. In the example of where the seismic signal is classified by whether a magnitude envelope for a seismic signal portion in a given frequency band exceeds an associated frequency content threshold, the time at which the magnitude envelope exceeds the threshold may be determined and recorded as the onset timing for the classified seismic signal pertaining to that frequency band.

In one example, a seismic signal may be classified with either the frequency content classification “slow data” that classifies the seismic signal as relating to low frequency seismic energy (eg, P wave) or the frequency content classification “fast data” that classifies the seismic signal as relating to high frequency seismic energy in the acoustic band (eg, A wave). In one example, a frequency content classification corresponding to frequency band 920 (see FIG. 9) of 3.90-7.81 Hz is determined to be “slow data” (ie, corresponding to a P wave) and a frequency content classification corresponding to frequency bands 970 and 980 (see FIG. 9) of 125 Hz-500 Hz is determined to be “fast data” (ie, corresponding to an acoustic wave). To supplement classifications, in another example the S wave may also be classified by analysis corresponding to the frequency band 930 (7.81-15.625 Hz) and comprise another example of a “slow data” classification. As would be appreciated, this approach may also be extended to seismic signals corresponding to Rayleigh and/or Love waves by selecting an appropriate frequency band for the classification process.

Referring now to FIG. 10, there is shown a plot 1000 of the generated seismic signal portion 1020 in the frequency sub-band 3.90-7.81 Hz (ie, corresponding to “slow data” frequency content classification) depicting the seismic signal magnitude envelope 1030 in accordance with an illustrative embodiment. Also shown is the original full frequency seismic signal 1010. In accordance with the present disclosure, the onset time 1040 is then recorded as the time when the frequency content of this “slow data” classified seismic signal, as indicated in this example by magnitude envelope 1030, exceeds the associated frequency content threshold. As such, for each classified seismic signal that is associated with a respective seismic signal sensor there will be a respective determined seismic signal onset timing corresponding to when the classified seismic signal arrived at the seismic signal sensor.

In one example, where the frequency content classification for a classified seismic signal is an A wave, a check is made to determine that the onset timing is either not earlier than the onset timing of an associated P wave (as an example) or within a specified period of this onset timing. This is to discriminate against false detections of acoustic waves that may be caused by resonance of the seismometer which can resonate at frequencies in the acoustic band from an earlier seismic event. In one example, the specified period is 200 ms implying that a determination of location will not be made if the location is within approximately 70 m of the seismic signal detector 210.

Referring back to FIGS. 2 and 3, this onset timing may be converted to UTC time from GPS timestamps and for a given seismic signal detector 210, where the seismic signal was detected, this information may be communicated to server module 250 for determination of the location of the seismic event. In one example, a seismic signal detector 210 sends a message to the server module 250 comprising:

```
[
  Detector Node ID,
  Timestamp (eg, UTC time),
  Estimated time error,
  Frequency Content Classification (eg, P wave or A wave)
]
```

As each message is received by server module 250, they are cached until a minimum set of determined seismic signal onset timings has been received. In one example, a minimum set is determined by the reception of four or more messages denoting the different frequency content classifications (eg, both detection of one or more P waves and one or more A waves) within a certain time frame. This timeframe is based on the velocity of the type of event and the Euclidean distance between the outermost sensor detector node and the furthest expected distance of the seismic event.

In this example, once server module 250 captures a set of at least four events corresponding to seismic signal detections within the relevant timeframe, these messages are further processed by system control module 230 of server module 250 to determine the location of the seismic event. As more messages containing seismic signal onset timings are received from detectors that detect respective seismic signals corresponding to the seismic event, they may then be appended to the existing minimum set to improve the determination of the location.

Referring back to FIG. 1, at step 140 the location of the seismic event is determined based on the respective seismic signal onset timings and respective frequency content classifications of the classified seismic signals corresponding to detected seismic signals.

Referring now to FIG. 11, there is shown a flowchart of a method 1100 for determining the location of the seismic event from seismic signal onset timings according to an illustrative embodiment corresponding in one example to step 140 of FIG. 1.

At step 1110 an initial location estimate for the location of the seismic event is determined. In one example, the order of the respective seismic detector and their associated seismic signal onset time is first determined by comparing their respective time values or time stamps. An example of an ordered set of seismic signal onset timing messages comprises:
[4, 0, ‘0.01’, ‘P’],
[9, 69, ‘0.01’, ‘P’],
[11, 91, ‘0.01’, ‘P’], and
[7, 268, ‘0.01’, ‘A’],

where in this example the time is referenced to the first detection time at seismic signal detector “4” which has been determined from raw GPS/UTC times by in this example server module 250. As would be appreciated, once the time ordered set has been determined the polygon defined by the bisecting lines from each pairing of nodes will allow the determination of ever shrinking polygons to eventually determine an initial area estimate for the location of the seismic event defined by the final polygon boundary.

Referring now to FIG. 12, there is shown a plot 1200 of an initial area estimate 1210 for the location of a seismic event determined according to the above illustrative method where there are twelve seismic signal detectors 210 (NOTE: only inner four detectors are shown in FIG. 12) where the respective seismic signal onset timings have been determined for in this example a significant subset of the twelve detectors. As can be seen in this example, increasing the number of detector nodes (eg, to 12), and the likely determination of more corresponding seismic signal onset timing messages for a seismic event, will in turn increase the number of bisecting lines and this improves the initial area estimate as the defined polygon becomes more constrained. In one example, where an inconsistency is detected for a particular seismic signal detector (eg, the proceeding detector infers a region outside of the previously defined polygon) then the location determining method will cease for that set of timing data.

Once the initial area estimate 1210 has been determined an initial location estimate 1260 may be determined by the mean of the vertices of the determined polygon. As would be appreciated, this initial location estimate may provide a satisfactory determination of the location of the seismic event depending on requirements.

At step 1120, a final location determination for the seismic event is generated based on the time difference of arrival of seismic signals and the initial location estimate and adopting an iterative minimisation approach to determine the location of the seismic event.

Initially the time of flight of the seismic signal is calculated by determining the Euclidean distance between a respective seismic signal detector 210 (which is known) and the initial location estimate for the seismic event. This is determined based on an initial estimate of the seismic wave velocity for the classified seismic signal which will be based on the frequency content classification.

As an example, for a seismic signal classified as an acoustic wave, the wave velocity will be the speed of sound. With temperature and humidity measurements, the average speed of sound of the array for a given time period may be calculated to a high degree of accuracy and may be adopted to reduce the degrees of freedom of the event localisation procedure by one. In another example, where the seismic signal has been classified as a “P” wave, the associated velocity estimate will be circa 4500 m/s. In another example, where the seismic signal has been classified as an “S” wave, the associated velocity estimate will be circa 2500 m/s. As would be appreciated, the particular values for these velocity estimates may be derived theoretically based on the seismic properties of the location and/or determined or refined by measurements carried out at the location.

Following determination of the time of flight for each seismic signal, the difference between this value and the respective measured onset timing may be used in a minimisation procedure where the initial location estimate is varied in order to minimise this difference to determine the location of the seismic event

In one example, a multilateral least squares method is adopted for this minimisation procedure and involves calculating an inverse covariance matrix C-1 which carries the reciprocal of the error along the diagonal. In one example, this error is defined to be a constant 0.01 seconds. In another embodiment, the expected error may be generated for each seismic signal based on the magnitude and derivative of the onset seismic signal that has been measured.

The derivative or Jacobian matrix, G, is then calculated based on the initial estimates of the seismic wave speed, impact location and impact time. A vector of residuals r is produced which is the difference between the time observed to and the time predicted for each seismic detector tp. The Jacobian matrix, inverse covariance matrix and residuals are then used in an iterative least squares scheme to re-estimate the seismic wave speed, impact location and impact time. Further, the matrix product is taken between the inverse covariance matrix and the vector of residuals. The product of this calculation is then multiplied with the transpose of the vector of residuals. This results in a χ² scalar value giving a general indication of the error in the solutions.

Formally, the arrival time prediction equation is defined by

$${t}_{P} = \frac{\sqrt{{( {X}_{sen} - X )}^{2} + {( {Y}_{sen} - Y )}^{2}}}{v} + t \qquad Equation 12$$

where ν, (X, Y) and t are the input supplied seismic wave speed, impact location and impact time respectively and Xₛₑₙ, Yₛₑₙ is the location of the seismic detector.

The vector of residuals is given by:

$$r = {t}_{o} - {t}_{p} \qquad Equation 13$$

and χ² is defined as follows

$${χ}^{2} = {r}^{T} {C}^{- 1} r \qquad Equation 14$$

The iterative least squares operator is given by:

$$B = {( {G}^{T} {C}^{- 1} G )}^{- 1} {G}^{T} {C}^{- 1} \qquad Equation 15$$

with the vector of the incremental changes then defined by:

$${d}_{sol} = Br \qquad Equation 16$$

which is then added to the previous solution

$${x}_{sol ( i )} = {x}_{sol ( i - 1 )} + {d}_{sol} \qquad Equation 17$$

ie, xₛₒₗ is solution vector containing some or all of the [seismic wave speed, impact location, impact time] parameters being solved for and dₛₒₗ is the update to the solution at stage (i) output by the iterative least squares scheme.

The vector of residuals r and Jacobian matrix G are then updated using the new solution and the process is iterated until χ² is minimised and stable. As would be appreciated, the value for χ² provides an indication of the relationship between the residuals and the error. If, for example, this value is high, there may be low correlation between the errors in the inverse covariance matrix and the residuals upon completion.

As would be appreciated, any iterative minimisation procedure which functions to determine the location of the seismic event based on the difference between the determined or calculated time of flight and the respective measured onset timings over the collection of seismic signals may be adopted in accordance with the present disclosure.

Referring now to FIG. 13, there is shown a plot 1300 of a location of a seismic event 1310 (shown in magnified region) as determined according to an illustrative embodiment as compared to the actual location 1320 of the seismic event. Plot 1300 also shows the three standard deviation ellipses 1331, 1332, 1333 as well as the initial area estimate 1340.

As can be seen from FIG. 13, the method in accordance with the present disclosure for determining the location of a seismic event in the form of an ordnance impact provides an accurate location estimate which may be conveniently deployed and provides coverage over an extended area.

In one example, the placement of the individual seismic signal detectors is optimised to improve the performance of the method of determining the initial area estimate in accordance with step 1110 of FIG. 11. In this example, seismic signal detectors 210 of location determining system 200 are placed to minimise the occurrence of co-linear detector nodes which increases the number of bisecting lines and in turn results in a larger number of polygons across the array area. As the number of polygons increases, the resolution increases which leads to increased accuracy in the initial estimates.

Referring now to FIG. 14, there is shown a plot 1400 of a spiral arm configuration 1410 for the placement of seismic signal detectors 210 according to an illustrative embodiment. In this example, the spiral arms 1410 are set at a regular spacing (ie, three in this example) and the seismic signal detectors are placed on intersecting equally spaced rings of increasing radius.

In another embodiment, the method 100 for determining the location of a seismic event further comprises determining a further seismic event characteristic of the seismic event. In one example, where the seismic event corresponds to an ordnance impact, the seismic event characteristic is whether the ordnance has exploded.

As can be seen from FIG. 5B, the frequency plot of the seismic signal corresponding to ordnance impact and subsequent explosion indicates that there is more energy in the acoustic frequencies of the frequency plot. In one example, the presence of energy in frequency band 970 and 980 (125-50 Hz) which is sufficiently above the mean noise threshold and is confirmed by several seismic signal detectors 210 within the array is sufficient to determine the presence of an explosion. As can be seen in FIG. 5A, the frequency content in frequency band 970 and 980 is either not discernible or is sufficiently low so as not to exceed the mean noise threshold. There may be instances where seismic signal detectors 210 may detect an A wave from a very close proximity unexploded bomb although it is unlikely to be confirmed by other seismic signal detectors 210 within the array.

In one example, where the seismic event corresponds to an ordnance impact whose location is to be determined, the method further comprises determining whether the ordnance has exploded or was unexploded. Referring again to FIGS. 5A and 5B, as can be seen from frequency plot 550 where there has been an ordnance impact and subsequent explosion there is more energy in the acoustic frequencies of the frequency plot as compared the unexploded ordnance where the frequency content in the acoustic band is either not discernible (on this scale) or is sufficiently low so as not to exceed the mean noise threshold.

Accordingly, in one embodiment determining whether the ordnance impact corresponded to an exploded ordnance or an unexploded ordnance comprises determining whether the frequency content in an acoustic frequency band exceeds an acoustic frequency threshold. In one example, this involves the determining of frequency content or energy in the acoustic frequency band (eg, frequency bands 970 and 980 (125-50 Hz) of FIG. 9) of the seismic signal and determining whether this is sufficiently above a mean noise threshold (which may be variable) in order to indicate an exploded ordnance. In another example, an exploded ordnance is indicated where there are two or more seismic signals corresponding to different detectors where energy is detected in the acoustic frequency band above threshold to provide further confirmation of the explosion.

In one example implementation comprising eighteen seismic signal detectors 210 covering an extended region of interest covering 30 square kilometres (array extended radially approximately 3 km from centre), a location determining system 200 in accordance with the present disclosure was able to determine the location of ordnance impacts with an average error of 20 m and further to discriminate whether an ordnance has exploded or was unexploded. Ordnance which has been tested includes 250 lb, 500 lb, 1000 lb and 2000 lb bombs.

In another example implementation comprising twelve seismic signal detectors 210, a relay module and mobile server module 250 covering a region of interest covering seven square kilometres (array extended radially approximately 1.5 km from centre), a location determining system 200 in accordance with the present disclosure successfully determined the location of plastic explosive charges of NEQ (Net Explosive Quantity) 1 kg, 2 kg and 4 kg which were detonated subsurface exhibiting similar seismic signatures to the ordnance above with an average error of 10 m. It is expected that the detection and location determining capability of the present system could span from ordnance impacts such as small rocket body impacts and mortar shell impacts though to large air dropped ordnance impacts.

As would be appreciated, method and systems for determining the location of a seismic event in accordance with the present disclosure represent a significant advance over present systems as they may be configured to cover an extended areas and are unaffected by environmental conditions that would otherwise reduce the effectiveness of camera based systems. Additionally, for those embodiments where seismic signals corresponding to acoustic energy are detected and classified, and whose onset timings are determined, the higher frequency of these acoustic waves will improve the seismic event location accuracy over an embodiment just based on detecting low frequency seismic energy.

It will be appreciated that the various illustrative logical blocks, modules and method steps described in connection with the above described embodiments disclosed may be implemented as electronic hardware, computer software or instructions, or combinations of both. To clearly illustrate this interchangeability of hardware and software, various illustrative components, blocks, modules, circuits, and steps have been described above generally in terms of their functionality as will providing example implementations. Whether such functionality is implemented as hardware or software depends upon the particular application and design constraints imposed on the overall system and the described functionality may be implemented in varying ways for each particular application, but such implementation decisions should not be interpreted as causing a departure from the scope of the present disclosure.

As an example, in the above described location determining system 200 the various signal processing calculations may be carried out substantially in real time or alternatively the seismic signal data may be collected and stored in order to be processed offline in accordance with the present disclosure. In other examples, some of the data processing may occur substantially in real time (eg, determination of onset timings) while the final determination of location may be determined in a post-processing step. Furthermore, the various signal processing calculations are identified as being carried out by particular data processing components of the system.

As would be appreciated, in other embodiments the data processing may be carried out by, or integrated with other modules of the system. In one example, the frequency content classification operation may be carried out by the individual seismic signal detector responsible for detecting the corresponding detected seismic signal and the remaining operations of determining the seismic signal onset timings and determining the location of the seismic event may be determined by the server module. In another example, both the frequency content classification and determination of seismic signal timing may be determined by the individual seismic signal detector responsible for detecting the corresponding detected seismic signal. In yet another example, a selected seismic signal detector may incorporate the functionality of a server module.

It will be understood that the terms “comprise” and “include” and any of their derivatives (eg comprises, comprising, includes, including) as used in this specification is to be taken to be inclusive of features to which the term refers, and is not meant to exclude the presence of any additional features unless otherwise stated or implied

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A method for determining a location of a seismic event comprising:
detecting three or more seismic signals in seismic activity associated with the seismic event that is monitored by three or more geographically spaced apart seismic signal detectors;
for each of the detected seismic signals detected by a respective seismic signal detector:
classifying, by the respective seismic signal detector a corresponding detected seismic signal with a respective frequency content classification based on determining whether a frequency content of the corresponding detected seismic signal exceeds a frequency content threshold;
determining for each of the classified seismic signals a respective seismic signal onset timing corresponding to an arrival time of the classified seismic signal at the respective seismic signal detector; and
determining the location of the seismic event based on the respective seismic signal onset timings and the respective frequency content classifications of each of the classified seismic signals.

2. The method of claim 1, wherein the frequency content threshold varies in accordance with an ambient frequency content for the respective frequency content classification.

3. The method of claim 1, wherein determining for each of the classified seismic signals the respective seismic signal onset timing comprises determining when the frequency content of classified seismic signal exceeded the frequency content threshold.

4. The method of claim 1, wherein classifying by the respective seismic signal detector the corresponding detected seismic signal with the respective frequency content classification comprises:
deconstructing the corresponding detected seismic signal into a plurality of frequency bands; and
determining the respective frequency content classification by identifying in which frequency band or bands the seismic signal exceeds the frequency content threshold.

5. The method of claim 1, wherein detecting three or more seismic signals in seismic activity monitored by three or more seismic detectors comprises determining for each of the seismic signals whether a power measure of the seismic signal exceeds a power measure threshold.

6. The method of claim 5, wherein the power measure threshold varies in accordance with an ambient value of the power measure.

7. The method of claim 5, wherein the power measure is a normalised harmonic power of the seismic signal and the power measure threshold is a harmonic power threshold.

8. The method of claim 5, wherein a duration that the power measure of the seismic signal exceeds the power measure thresholds defines a time window for the seismic signal for classifying the seismic signal.

9. The method of claim 1, wherein
determining the location of the seismic event comprises:
determining an initial location estimate of the seismic event;
determining a time of flight for each detected seismic signal based on a distance between its respective seismic signal detector and the initial location estimate and a velocity estimate based on the respective frequency content classification of the corresponding detected seismic signal; and
varying the initial location estimate to minimise the difference between the determined time of flight and the measured onset timing for each detected seismic signal to determine the location of the seismic event.

10. The method of claim 9, wherein determining the initial location estimate of the seismic event comprises determining an initial location area based on an order of arrival of the three or more seismic signals based on the respective seismic signal onset timings of the classified seismic signals.

11. The method of claim 1, wherein the seismic event is an ordnance impact.

12. The method of claim 11, further comprising determining whether the ordnance impact corresponds to an exploded ordnance or an unexploded ordnance.

13. The method of claim 12, wherein determining whether the ordnance impact corresponds to an exploded ordnance or an unexploded ordnance comprises determining whether the frequency content in an acoustic frequency band exceeds an acoustic frequency threshold.

14. The method of claim 1, wherein determining the respective seismic signal onset timing is determined by the respective seismic signal detector.

15. The method of claim 1, wherein the location of the seismic event is determined substantially in real time following detecting the three or more seismic signals.

16. A location determining system for determining the location of a seismic event comprising:
three or more geographically spaced apart seismic signal detectors for monitoring seismic activity associated with the seismic event, each of the three or more seismic signal detectors comprising one or more data processors and configured for:
detecting a seismic signal in seismic activity monitored by the seismic signal detector; and
classifying a corresponding detected seismic signal with a respective frequency content classification based on determining whether a frequency content of the corresponding detected seismic signal exceeds a frequency content threshold; a server module comprising one or more data processors and configured for:
determining for each of the classified seismic signals a respective seismic signal onset timing corresponding to an arrival time of the classified seismic signal at a respective seismic signal detector of the three or more seismic signal detectors; and
determining the location of the seismic event based on the respective seismic signal onset timings and the respective frequency content classifications of each of the classified seismic signals.

17. The location determining system of claim 16, wherein the frequency content threshold varies in accordance with an ambient frequency content for the respective frequency content classification.

18. The location determining system of claim 16, wherein
determining for each of the classified seismic signals the respective seismic signal onset timing comprises determining when the frequency content of classified seismic signal exceeded the frequency content threshold.

19. The location determining system of claim 16, wherein classifying the corresponding detected seismic signal with the respective frequency content classification comprises:
deconstructing the corresponding detected seismic signal into a plurality of frequency bands; and
determining the respective frequency content classification by identifying in which frequency band or bands the deconstructed seismic signal exceeds the frequency content threshold.

20. The location determining system of claim 16, wherein detecting three or more seismic signals in seismic activity monitored by three or more seismic detectors comprises determining for each of the seismic signals whether a power measure of the seismic signal exceeds a power measure threshold.

21. The location determining system of claim 20, wherein the power measure threshold varies in accordance with an ambient value of the power measure.

22. The location determining system of claim 20, wherein the power measure is a normalised harmonic power of the seismic signal and the power measure threshold is a harmonic power threshold.

23. The location determining system of claim 20, wherein a duration that the power measure of the seismic signal exceeds the power measure thresholds defines a time window for the seismic signal for classifying the seismic signal.

24. The location determining system of claim 16, wherein determining the location of the seismic event comprises:
determining an initial location estimate of the seismic event;
determining a time of flight for each detected seismic signal based on a distance between its respective seismic signal detector and the initial location estimate and a velocity estimate based on the respective frequency content classification of the corresponding detected seismic signal; and
varying the initial location estimate to minimise the difference between the determined time of flight and the measured onset timing for each detected seismic signal to determine the location of the seismic event.

25. The location determining system of claim 22, wherein determining the initial location estimate of the seismic event comprises determining an initial location area based on an:
order of arrival of the three or more seismic signals based on the respective seismic signal onset timings of the classified seismic signals.

26. The location determining system of claim 16, wherein the seismic event is an ordnance impact.

27. The location determining system of claim 24, further comprising determining whether the ordnance impact corresponds to an exploded ordnance or an unexploded ordnance.

28. The location determining system of claim 25, wherein determining whether the ordnance impact corresponds to an exploded ordnance or an unexploded ordnance comprises determining whether the frequency content in an acoustic frequency band exceeds an acoustic frequency threshold.

29. The location determining system of claim 16, where instead of the server module, each of the three or more seismic signal detectors is configured for determining a respective seismic signal onset timing corresponding to an arrival time of the classified seismic signal at the respective seismic signal detector.

30. The location determining system of claim 16, wherein the location of the seismic event is determined substantially in real time following detection of three or more seismic signals.

31. (canceled)

32. (canceled)

33. (canceled)
